(19) United States
(12) Patent Application Publication
(10) Pub. No.: US 2024/0185611 A1
(43) Pub. Date: Jun. 6, 2024

(54) IMAGE SIGNAL PROCESSING (ISP) TUNING WITH DOWNSTREAM PERCEPTION METRIC IN AUTONOMOUS DRIVING

(71) Applicant: Apollo Autonomous Driving USA LLC, Sunnyvale, CA (US)

(72) Inventors: Szu-Hao WU, Sunnyvale, CA (US); Shu JIANG, Sunnyvale, CA (US); Lyu Jeong HO, Sunnyvale, CA (US); Linpeng CHENG, Sunnyvale, CA (US); Hao LIU, Sunnyvale, CA (US); Helen K. PAN, Sunnyvale, CA (US)

(21) Appl. No.: 18/060,713

(22) Filed: Dec. 1, 2022

(51) Int. Cl. G06V 20/58; B60W 60/00

(52) U.S. Cl. CPC G06V 20/58; B60W 60/001; B60W 2420/42; B60W 2420/52

(57) ABSTRACT

A computing device may obtain one or more raw images captured from sensors of an autonomous driving vehicle (ADV). The computing device may apply one or more signal processing parameters to one or more raw images, resulting in one or more processed images. The computing device may apply an object detection algorithm of the ADV to the one or more processed images. The computing device may determine a score of the object detection algorithm as applied to the one or more processed images. One or more optimized signal processing parameters may be determined based on the score of the object detection algorithm and the signal processing parameter. The one or more optimized signal processing parameters may be used to configure the ADV for use during autonomous driving.

### FIELD

Embodiments of the present disclosure relate generally to operating autonomous driving vehicles. More particularly, embodiments of the disclosure relate to image signal processing for autonomous driving vehicles.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Motion planning and control are critical operations in autonomous driving. However, conventional motion planning operations estimate the difficulty of completing a given path mainly from its curvature and speed, without considering the differences in features for different types of vehicles. Same motion planning and control is applied to all types of vehicles, which may not be accurate and smooth under some circumstances.

An autonomous driving vehicle (ADV) may include multiple image sensors (e.g., cameras) to capture a surrounding environment of the ADV. The surrounding environment may include the physical environment around the ADV such as roads, other vehicles, buildings, people, objects, etc. Each image sensor may produce one or more images that, when taken consecutively, may form an image stream. The number of image sensors may vary from one vehicle to another. Various image sensors may be placed at different positions to capture the environment from its perspective, such as from a given location at a given angle relative to the ADV.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect of this disclosure are not necessarily to the same aspect, and they mean at least one. Also, in the interest of conciseness and reducing the total number of figures, a given figure may be used to illustrate the features of more than one aspect, and not all elements in the figure may be required for a given aspect. It should be understood that some of the embodiments shown may be combined with other embodiments even if not shown as such in each figure.

FIG. 1 is a block diagram illustrating a networked system according to one embodiment.

FIG. 2 is a block diagram illustrating an example of an autonomous driving vehicle according to one embodiment.

FIG. 3A shows a block diagram illustrating an example of an autonomous driving system used with an autonomous driving vehicle according to one embodiment.

FIG. 3B shows a block diagram illustrating an example of an autonomous driving system used with an autonomous driving vehicle according to one embodiment.

FIG. 4 is a block diagram illustrating system architecture for autonomous driving according to one embodiment.

FIG. 5 shows an example tuning system in accordance with some embodiments.

FIG. 6 shows an example of an objective score in accordance with some embodiments.

FIG. 7 shows an example of an ADV with a configured image signal processor, in accordance with some embodiments.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

Under traditional methods, an autonomous vehicle may have sensors that generate raw images. These raw images may be used by the autonomous vehicle to sense its surroundings. Based on the ADV's sensing (e.g., perception), the ADV may make driving decisions such as generating a series of control commands that are then applied to control actuators (e.g., a brake, a throttle, a steering actuator) to effect movement of the ADV. For example, the ADV may sense its position relative to a driving lane and generate steering and throttle commands to move the ADV along the driving lane. Similarly, the ADV may sense presence of an object (e.g., another vehicle, or a pedestrian) and generate a series of control commands to avoid or overtake the object.

Traditionally, an image signal processor may modify or adjust raw images from a camera to improve the quality of the images. An image signal processor may include various image signal processor (ISP) parameters that define how the image signal processor modifies the raw image. These ISP parameters are traditionally adjusted by a person, in a calibration phase. For example, raw test images may be processed by an image signal processor. A test tool may compare the resulting processed images to a desired result and generate an error. A human may adjust the ISP parameters until those errors are reduced to a satisfactory level. Such a technique has drawbacks. For example, traditional techniques rely on a human to manually tune the ISP parameters over numerous iterations, which may be time consuming and error prone. Further, the dedicated test tool used in traditional techniques simply compare the processed images with a desired image or set of metrics, and may not accurately reflect performance in an ADV environment. In particular, these metrics may not improve accuracy of perception (e.g., object detection) by the ADV.

For example, tuning the ISP parameters to reduce the error between the desired result (e.g., standard metrics) and the processed images may not result in an overall improved performance of an ADV's perception module. Further, such a technique does not account for different driving conditions or scenarios, which may influence how those images should be processed.

Therefore, it is desirable to automatically tune an image signal processor (e.g., without human intervention). Further, it is desirable to tune the image signal processor based on ADV specific criteria, rather than comparison with a static set of images or static criteria performed by a traditional tool. Further, the image signal parameters may be associated with different scoring criteria or with different driving condition so that the ADV may dynamically select which image signal processing parameters to use, based on different conditions or scenarios.

An ISP may include multiple modules or operations such as, for example, Auto Weight Balance (AWB), Color Correction Matrix (CCM), etc. Each operation may include its own tuning criterion. For example, the AWB module may use weight balance error as criterion. The CCM module may use color error as criterion. Traditionally, these modules are tuned manually based on trial and error. As described, however, this approach has drawbacks: error of each module may not directly reflect error of downstream perception; and manual testing may be labor intensive.

In some embodiments, an image signal processing (ISP) tuning service with downstream perception metrics is described. In autonomous driving system, ISP may directly influence accuracy of an ADV's perception module. Embodiments of the disclosure include an ISP tuning pipeline that may include perception metrics as tuning criteria. In such a manner, the tuning pipeline may more effective improve the ADV's perception accuracy in autonomous driving over the traditional tuning techniques.

In one aspect, a method may be performed by an automated tuning service. The method may comprise obtaining one or more raw images captured from sensors of an autonomous driving vehicle (ADV); applying a signal processing parameter to one or more raw images, resulting in one or more processed images; applying an object detection algorithm of the ADV to the one or more processed images; determining a score of the object detection algorithm as applied to the one or more processed images; and determining an optimized signal processing parameter based on the score of the object detection algorithm and the signal processing parameter, wherein the optimized signal processing parameter is uploaded to the ADV for autonomous driving. Other aspects are described.

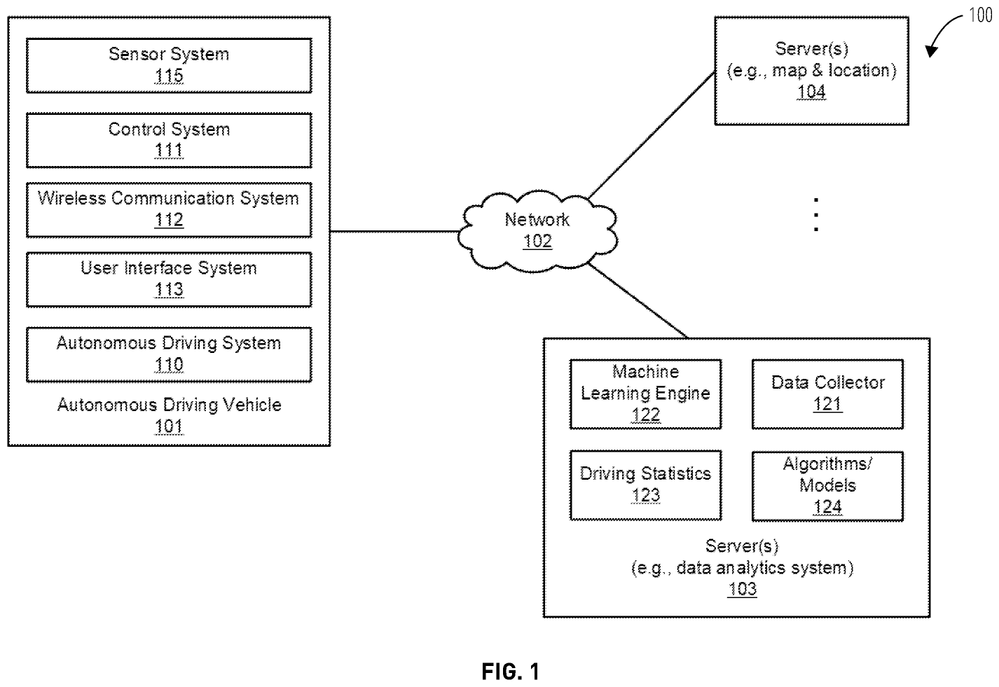

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

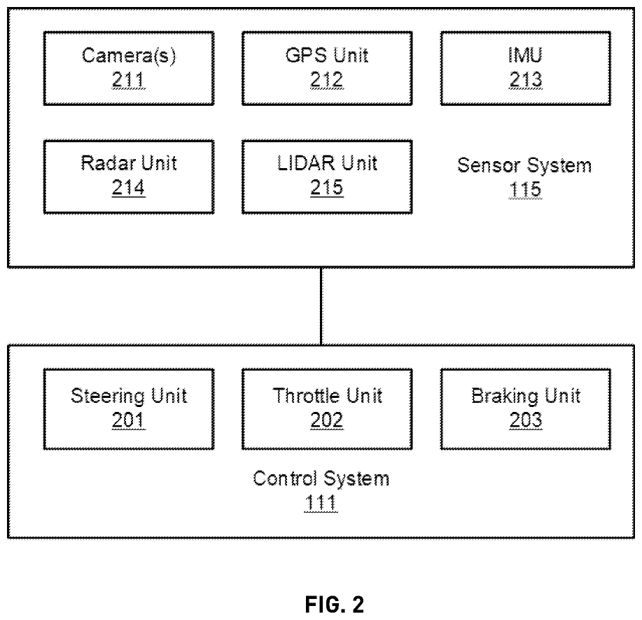

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using Wi-Fi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third-party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently. Server 103 may be a data analytics system to perform data analytics services for a variety of clients. In one embodiment, data analytics system 103 includes data collector 121 and machine learning engine 122. Data collector 121 collects driving statistics 123 from a variety of vehicles, either ADVs or regular vehicles driven by human drivers. Driving statistics 123 include information indicating the driving commands (e.g., throttle, brake, steering commands) issued and responses of the vehicles (e.g., speeds, accelerations, decelerations, directions) captured by sensors of the vehicles at different points in time. Driving statistics 123 may further include information describing the driving environments at different points in time, such as, for example, routes (including starting and destination locations), MPOIs, road conditions, weather conditions, etc.

Based on driving statistics 123, machine learning engine 122 generates or trains a set of rules, algorithms, and/or predictive models 124 for a variety of purposes. Algorithms 124 can then be uploaded on ADVs to be utilized during autonomous driving in real-time.

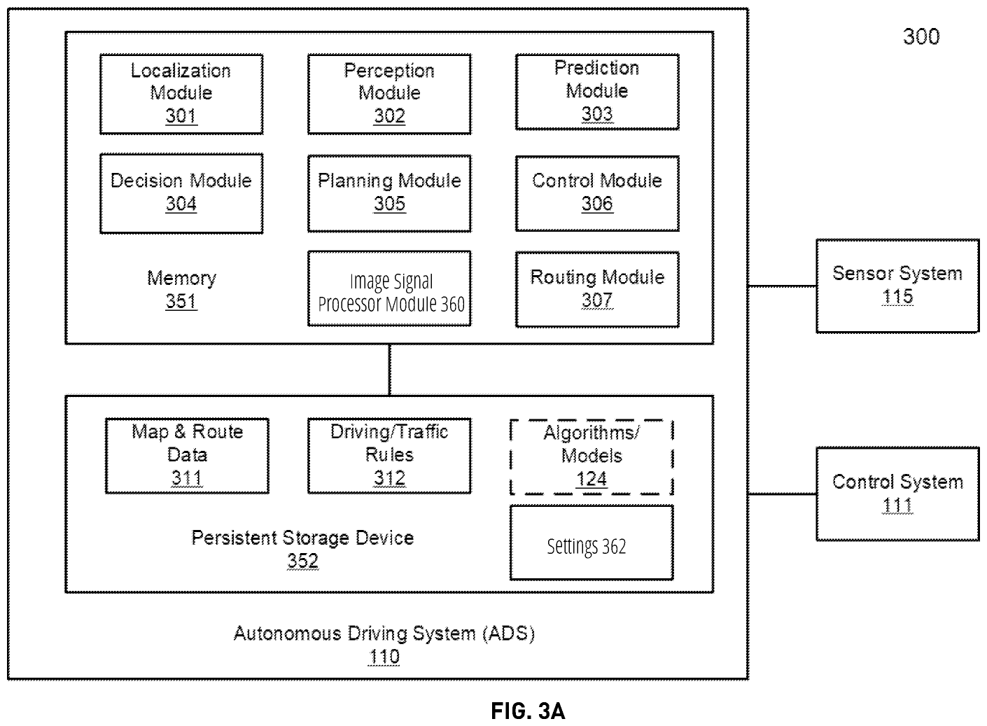

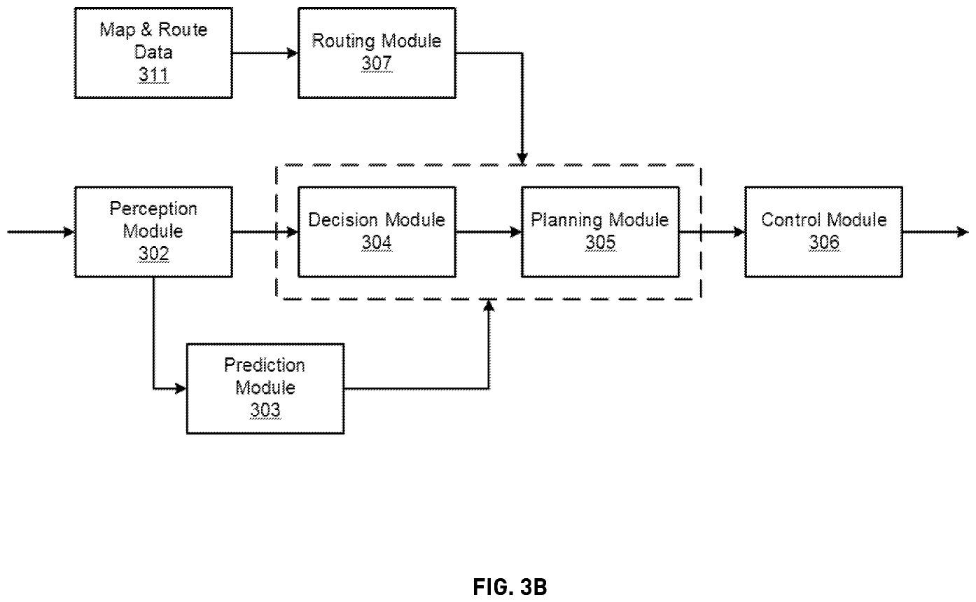

FIG. 3A and FIG. 3B are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. Referring to FIGS. 3A-3B, ADS 110 includes, but is not limited to, localization module 301, perception module 302, prediction module 303, decision module 304, planning module 305, control module 306, routing module 307 [fill in additional modules here].

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 101 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 101, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 101 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, roadway boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 makes a decision regarding how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

In some embodiments, autonomous driving system 300 includes an image signal processor module 360. Image signal processor module 360 may utilize configurable settings 362 which may be stored in persistent storage device 352. The configurable settings may include one or more image signal processor parameters that the image signal processor may use to process raw images from sensor system 115. The settings 362 may be configured offline by a networked computing device.

For example, an image signal processor tuning service (as described in other examples) running on a computing device may upload one or more image signal processor parameters to the autonomous driving vehicle system 300 to be stored in settings 362.

In some embodiments, the computing device may obtain one or more raw training images captured from cameras 211 of sensor system 115 of the autonomous driving vehicle system 300. The computing device may apply one or more signal processing parameters to one or more raw training images, resulting in one or more processed images. The computing device may apply an object detection algorithm of the ADV to the one or more processed images. The object detection algorithm may be the same as that used in perception module 302 of the autonomous driving vehicle system 300. The computing device may determine a score (e.g., an objective score) of the object detection algorithm as applied to the one or more processed images. The score may include one or more object detection metrics, as described in other sections. The computing device may determine the one or more optimized signal processing parameters based on the score of the object detection algorithm and the one or more signal processing parameters. The computing device may configure the settings 362 with the optimized signal processing parameters.

Some or all of the operations described in relation to determining the optimized signal processing parameters and uploading them onto the autonomous driving vehicle system 300 may be performed automatically (e.g., without intervention of a human). In some embodiments, the computing device may push updates of the one or more optimized signal processing parameters to the autonomous driving vehicle in response to a change in the perception module 302 (e.g., its object detection algorithm), or in response to a change to cameras 211, or periodically, or a combination thereof. In some embodiments, settings 362 may include logic that indicates which set of the one or more optimized parameters should be applied (e.g., based on current conditions of the ADV, a driving scenario, etc.), as described in other sections.

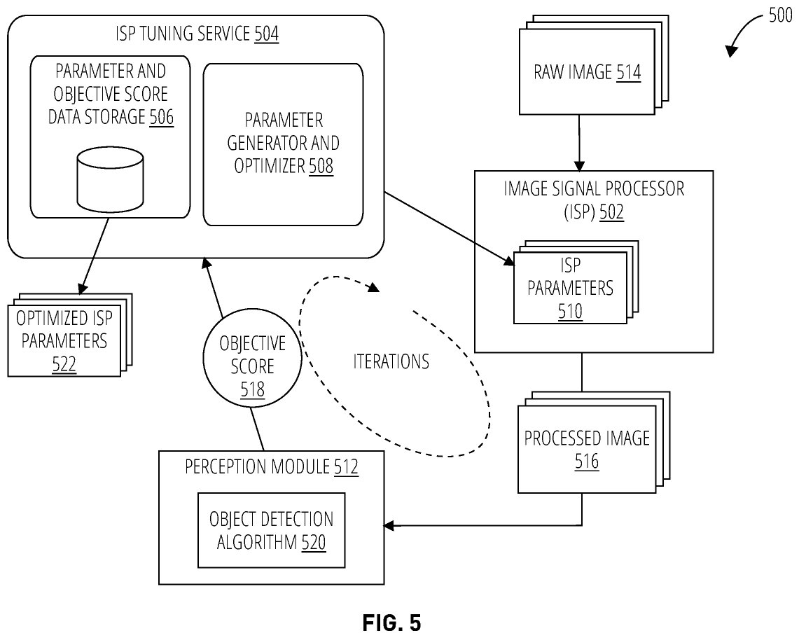

In some embodiments, cameras 211 may be used for perception, as described, as well as for gathering data for off-line use. The off-line data may be compressed with signal compression module 360 as described. As such, the cameras 211 may be used for dual purposes, such as for driving the ADV and for data gathering. Signal compression module 360 may correspond to a signal compression module described in other sections (e.g., with respect to FIG. 5).

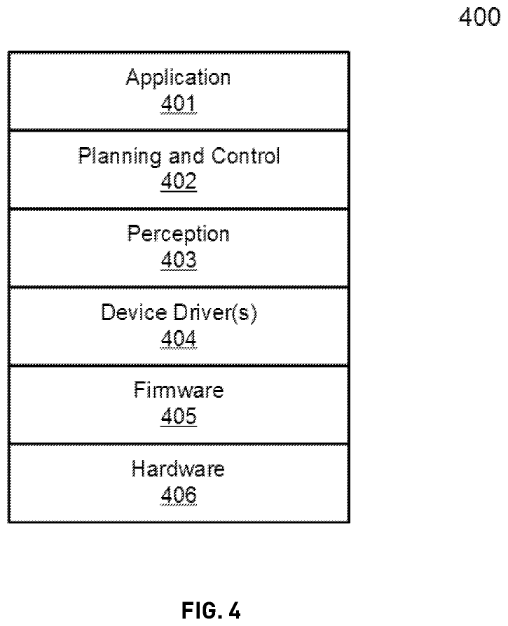

FIG. 4 is a block diagram illustrating system architecture for autonomous driving according to one embodiment. System architecture 400 may represent system architecture of an autonomous driving system as shown in FIG. 3A and FIG. 3B.

Referring to FIG. 4, system architecture 400 includes, but it is not limited to, application layer 401, planning and control (PNC) layer 402, perception layer 403, driver layer 404, firmware layer 405, and hardware layer 406. Application layer 401 may include user interface or configuration application that interacts with users or passengers of an autonomous driving vehicle, such as, for example, functionalities associated with user interface system 113. PNC layer 402 may include functionalities of at least planning module 305 and control module 306. Perception layer 403 may include functionalities of at least perception module 302.

In one embodiment, there is an additional layer including the functionalities of prediction module 303 and/or decision module 304. Alternatively, such functionalities may be included in PNC layer 402 and/or perception layer 403.

System architecture 400 further includes driver layer 404, firmware layer 405, and hardware layer 406. Firmware layer 405 may represent at least the functionality of sensor system 115, which may be implemented in a form of a field programmable gate array (FPGA). Hardware layer 406 may represent the hardware of the autonomous driving vehicle such as control system 111. Layers 401-403 can communicate with firmware layer 405 and hardware layer 406 via device driver layer 404.

In some examples, the image signal processor may be implemented in the perception layer 403 or in the device driver layer 404, or a combination thereof. For example, the image signal processor may modify raw images obtained from the camera sensors and provide them to an object recognition algorithm within the perception layer 403.

FIG. 5 shows an example tuning system 500 in accordance with some embodiments. The tuning system 500 may be an automated tuning system that operates without human intervention or input. Some or all of the blocks of system 500 may be implemented by processing logic that comprises hardware (e.g., circuitry, dedicated logic, etc.), software (e.g., embodied on a non-transitory computer readable medium), or a combination of both.

As described, sensors such as a camera of an autonomous driving vehicles may generate one or more raw images that capture the surroundings of the ADV. Those raw images may be processed to improve image quality for further downstream processing by the ADV.

Generally, system 500 may obtaining one or more raw images 514 captured from sensors of an autonomous driving vehicle (ADV). In some embodiments, the raw images 514 may be obtained from sensors of an ADV. These sensors need not be integrated on an ADV, but may be duplicates of those integrated within an ADV.

System 500 may (at image signal processor 502) apply one or more signal processing parameters 510 to the one or more raw image 514, resulting in one or more processed images 516. System 500 may (at perception module 512) apply an object detection algorithm 520 of the ADV to the one or more processed images 516. The system 500 may determine a score 518 of the object detection algorithm 520 as applied to the one or more processed images 516. System 500 (at ISP tuning service 504) may determine an optimized signal processing parameter 522 based on the score 518 of the object detection algorithm and the image signal processing parameter 510.

In some embodiments, determining the optimized signal processing parameter includes determining and applying a plurality of signal processing parameters 510 (e.g., at multiple iterations of the shown workflow) and selecting one of the plurality of signal processing parameters that corresponds to a highest score of the object detection algorithm 520. For example, the optimized image signal processor parameters 522 may be determined after multiple iterations of generating ISP parameters 510, processing raw images with those ISP parameters, and detecting objects in the processed images 516, until the object objective score 518 satisfies a threshold, or reaches a peak, or both.

ISP tuning service 504 may generate one or more ISP module parameters 510 that configure how image signal processor 502 adjusts one or more raw images 514. The ISP tuning service 504 may generate a baseline set of ISP parameters, which may be default parameters or randomly generated parameters. The image signal processor 502 may have one or more modules that each utilize a respective one of the ISP parameters 510 to modify each of the raw image 514.

For example, the ISP parameters 510 may include a “static white balance gain” that configures an Auto White Balance (AWB) module in the image signal processor to adjust the white balance in each of the raw images according to the gain.

Similarly, the ISP parameters 510 may include a “color saturation” parameter in a Color Correction Matrix (CCM) module of the image signal processor 502 that configures the CCM module to perform color correction according to the color saturation parameter.

In another example, the ISP parameters 510 may include a “noise reduction strength” that configures a Noise Reduction module of the image signal processor 502 to reduce the noise in each of the raw images based on the noise reduction strength. The ISP parameters 510 may include various other signal processing parameters that correspond to other signal processing modules that adjust raw images.

The image signal processor 502 adjusts the one or more raw images 514 according to these ISP parameters 510, resulting in one or more processed images 516. These processed images 516 are fed as input to perception module 512. Perception module 512 may include an object detection algorithm 520. Object detection algorithm 520 may utilize a machine learning algorithm or a computer vision algorithm to detect objects that are present in the processed images 516. Given an image or a video stream, object detection algorithm 520 can identify which of a known set of objects might be present and provide information about their positions within the image (e.g., with a bounding box). The object detection algorithm 520 may be trained to detect and locate objects within each image.

For example, the algorithm may be trained with images that contain various objects such as vehicles, pedestrians, bicycles, or other objects, along with a label that specifies the class of object they represent (e.g., vehicle, pedestrian, bicycle, etc.), and data specifying where each object appears in the image. When an image is subsequently provided to the object detection algorithm 520, it may output a matrix or list of the objects it detects, the location of a bounding box that contains each object, and a score that indicates the confidence that detection was correct.

The system may determine an objective score 518 from the perception module 512. This determination may be made based on the output of the perception module 512, as described in other sections. The objective score 518 may be determined based on ground truth (which may include what is really in the raw images 514 and the processed images 516), and what the perception module 512 detected or did not detect in the one or more processed images 516.

The ISP tuning service 504 may obtain the objective score 518 and generate another set of ISP module parameters which reconfigures the image signal processor 502 to adjust the raw images 514 and produce a second set of processed images 516. The perception module 512 may apply its object detection algorithm 520 to the second set of processed images 516 to detect objects in those processed image 516. A second objective score 518 may be determined. The parameter generator and optimizer 508 of the ISP tuning service 504 may generate a third set ISP parameters 510, and so on.

For each such iteration, the ISP tuning service 504 may store the objective score and the ISP parameters corresponding to that objective score in parameter and objective score data storage 506. Each time the ISP tuning service 504 determines the ISP parameters 510, it may reference the data storage 506 to determine and follow a trend if one is present. For example, parameter generator and optimizer 508 may determine, based on historical data of the objective score, that increasing ISP parameter ‘X’ results in an increase or improvement in the objective score 518. As such, for each iteration, parameter generator and optimizer 508 may increase ISP parameter ‘X’ until the objective score 518 no longer improves, or until it becomes worse. Based on the historical data which includes the relationship between the ISP parameters and the objective score 518 generated from those ISP parameters, the ISP tuning service 504 may find the optimized image signal processor parameters 522 that adjust the raw images 514 such that the perception module 512 optimally detect objects in the processed images 516. The one or more optimized image signal processor parameters 522 may be selected as the one or more ISP parameters 510 that yielded the best objective score 518 over multiple iterations.

In some embodiments, parameter generator and optimizer 508 may use a random number generator to randomly generate ISP parameters 510. The resulting objective score 518 may be observed with respect to previously determined objective scores stored in parameter and objective score data storage 506, to determine a next set of ISP parameters 510 for the next iteration.

The parameter generator and optimizer 508 may utilize one or more optimization algorithms to determine the optimized image signal processor parameters 522. An optimization algorithm may include a procedure which is executed iteratively by comparing various solutions (e.g., previous ISP parameters and their corresponding scores stored in parameter and objective score data storage 506) until an optimum or a satisfactory solution is found. The optimization algorithm can utilize historical data and trends to determine which direction the ISP parameters should be generated for each iteration. Examples of optimization algorithms include a differentiable objective function (e.g., using a first-order derivative, gradient, partial derivative, second-order derivative, etc.), a bracketing algorithm (e.g., a Fibonacci search, golden section search, bisection method, etc.), a local descent algorithm (e.g., a line search), first-order algorithms (e.g., gradient descent, momentum, Adagrad, Adam, etc.), second order algorithms, direct algorithms, non-differential objective functions, or other optimization algorithms.

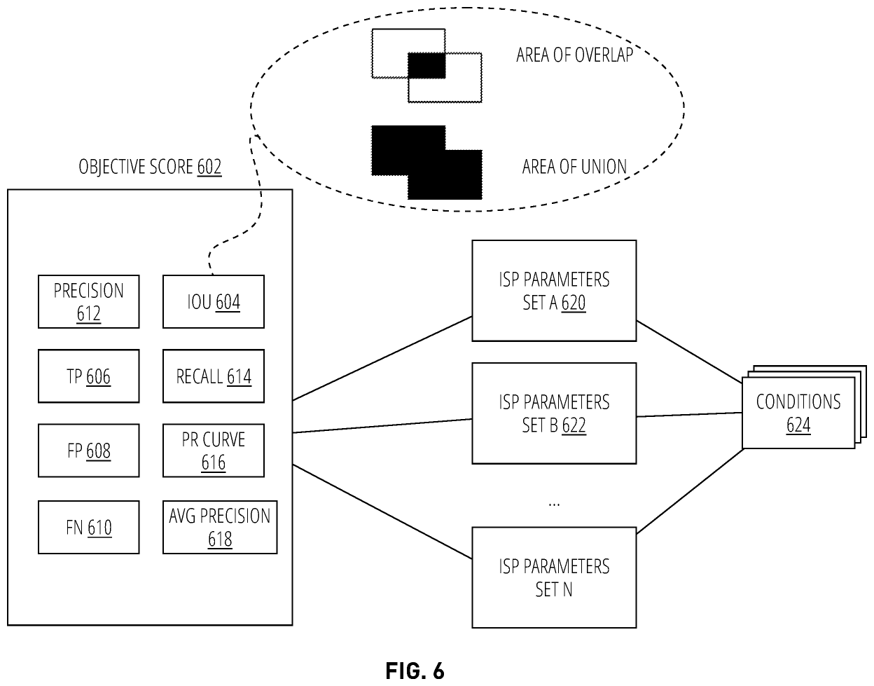

FIG. 6 shows an example of an objective score 602 in accordance with some embodiments. Objective score 602 may be determined by processing logic such as processing logic of system 500. The objective score 602 may correspond to objective score 518 as shown in FIG. 5.

An objective score 602 may include one or more metrics that indicate how well the perception module (e.g., 512) performed with a given set of one or more processed images. The metrics may include an intersection over union 604, a true positive 606, a false positive 608, a false negative 610, precision 612, recall 614, a precision and recall curve 616, an average precision 618, and/or other metrics.

In some embodiments, objective score 602 may include an Intersection over Union (IOU) 604 that is determined based on area of overlap of a detected bounding box and ground truth and an area of union of the detected bounding box and the ground truth. The IOU may quantify the degree of overlap between two boxes (ground truth and bounding box). The bounding box is an area drawn around a detected object by the object detection algorithm (e.g., 520) which may indicate a size of the detected object and where the detected object is in the image (the processed image). It may be defined by a set of coordinates (e.g., x and y coordinates of the image). Ground truth refers to trusted data that the system compares the efforts of the perception module (e.g., the object detection algorithm) against. Ground truth may include a box drawn around an object in the same image, representing where a physical object really is in the image. Difference between the bounding box (as output by the ADV's perception module) and the ground truth represents an error. In some examples, the IOU 604 may be expressed as (area of overlap of detected bounding box and ground truth)/(area of union of detected bounding box and ground truth).

In some embodiments, the objective score 602 score is further determined based on one or more true positives 606 determined based on a ratio of the area of overlap of the detected bounding box and the ground truth and the area of union of the detected bounding box and the ground truth. For example, a true positive may be referred to as a correct detection of an object in an image. The true positive may be indicated when the IOU satisfies a threshold value.

In some embodiments, the score 602 is further determined based on one or more false positives 608 determined based on a ratio of the area of overlap of the detected bounding box and the ground truth and the area of union of the detected bounding box and the ground truth. For example, a false positive may be referred to as an incorrect detection of an object in an image. The false positive may be determined when the IOU does not satisfy the threshold value.

In some embodiments, the score 602 may be determined based on one or more false negatives 610 that are determined based on the ground truth that is not detected in the image. For example, a false negative may occur when an object is in an image (e.g., a processed image) but is not detected by the perception module.

In some embodiments, the score 602 may include precision 612, which describes how precise the perception module detects objects in the processed images. Precision may be determined based on the amount or number of true positives and false positives. In some embodiments, precision may be expressed or determined as (true positive)/(true positive/false positive).

In some embodiments, the score 602 may include a recall 614, which may be determined based on the amount or number of true positives and false negatives. In some embodiments, recall may be determined or expressed as (TP)/(TP+FN).

In some embodiments, the score 602 may include a precision and recall curve 616 that may include the relationship (e.g., a graph) between the precision and the recall. In some embodiments, the score 602 may include an average precision 618 taken over processing of many images (with the same ISP parameters).

In some embodiments, processing logic may determine multiple sets of ISP parameters such as, for example, ISP parameters set A 620, ISP parameters set B 622, etc. Each set of parameters may correspond to a different one of conditions 624. For example, set A may correspond to an ambient brightness range of ‘X’ and set B may correspond to an ambient brightness range ‘Y’ that is darker than that of A. Processing logic may determine, based on testing (as discussed in other sections), that the objective score 602 is higher (or better) using set A when ambient brightness is brighter, or in the range of ‘X’. Processing logic may further determine that ISP parameters set B yield higher (or better) objective score under lower ambient brightness (e.g., range ‘Y’).

In some embodiments, processing logic may determine different sets of ISP parameters based on different metrics of the objective score. For example, set A may be generated as being optimal with respect to true positives, but set B may be optimal with respect to reducing false negatives. As such, the ADV may apply ISP parameters of set A under conditions when true positives are prioritized, but apply set B under conditions when false negatives are to be prioritized. For example, based on the vehicle speed, if the ADV is moving fast, it may want to emphasize reducing false negatives. In response, the ADV may dynamically select a set of ISP parameters that emphasizes reduction of false negatives.

Each set of ISP parameters may include one or more ISP parameters. The ISP parameter values of each set may be unique, although not necessarily. For example, set A may have auto white balance=‘a’, noise reduction strength=‘b’, and color saturation=‘c’. Set B may have auto white balance gain=‘a’, noise reduction strength=‘d’, and color saturation=‘e’, and so on.

As such, processing logic may configure an ADV with one or more ISP parameters or one or more sets of ISP parameters, each set having one or more ISP parameters. Each set may be associated with one or more conditions 624 so that an ADV may dynamically adjust its image signal processor with those ISP parameters, based on the current conditions of the ADV.

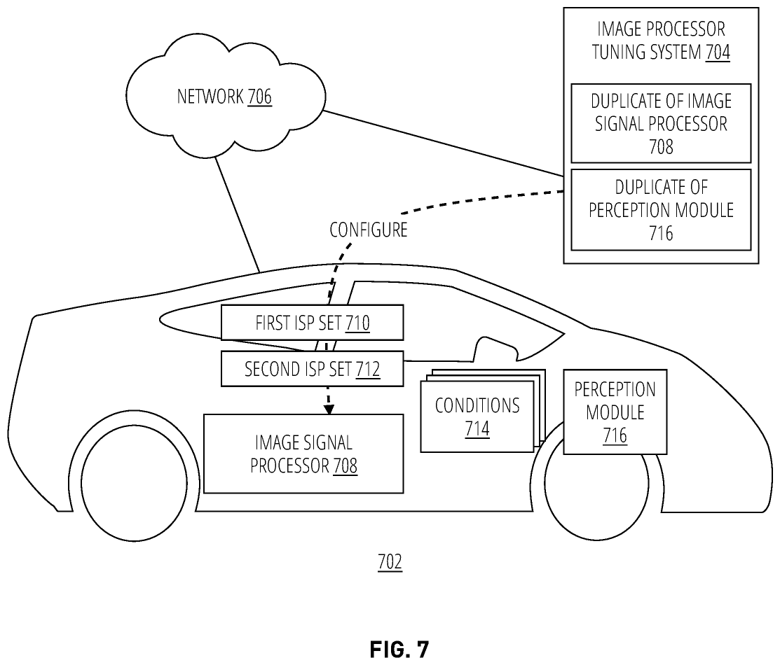

FIG. 7 shows an example of an ADV 702 with a configured image signal processor 708, in accordance with some embodiments. The ADV 702 may include an autonomous vehicle driving system such as autonomous vehicle driving system 300.

The ADV 702 may be communicatively connected to an image processor tuning system 704 via a network 706. Image processor tuning system 704 may correspond to system 500 as described in other sections. The image processor tuning system 704 may upload one or more ISP parameters (e.g., 710, 712) to image signal processor 708 of the ADV. Those one or more ISP parameters may be optimized ISP parameters.

For example, as described in other sections, image processor tuning system 704 may include a duplicate of image signal processor 708 that is used to process raw images (which may be obtained from sensors of ADV 702 or obtained from a test bank), and a duplicate of the ADV's perception module 716 that is used to generate objective scores. These objective scores indicate how well the duplicate perception module performed with a given set of ISP parameters. Based on the objective scores and multiple iterations of ISP parameters, the image processor tuning system 704 may determine the optimized ISP parameters (e.g., 710 or 712).

The image processor tuning system 704 may configure the image signal processor 708 on the ADV 702 with the optimized ISP parameters. For example, the optimized ISP parameters may be loaded to the ADV's settings. As such, the ADV 702 may utilize ISP parameters which are optimized for its perception module 716.

Further, as described, each set of optimized parameters may be associated with a corresponding one of conditions 714. In some embodiments, the image processor tuning system 704 may determine a first optimized ISP parameter (or set) 710 that is associated with a first condition 714 (e.g., an ambient brightness or other condition) and a second optimized ISP parameter (or set) 712 that is associated with a second condition (e.g., a second and different ambient brightness or other condition). The ADV 702 may apply the first optimized ISP 710 in response to sensing the first condition and apply the second optimized ISP (or set) 712 in response to sensing the second condition.

For example, the ADV 702 may determine that, based on the time of day or the sensed ambient light, the first ISP or set 710 is to be applied to raw images. At a different time, the ADV may determine that the sensed ambient light or time of day has changed, and in response, may apply the second ISP or set 712.

In some embodiments, the image processor tuning system 704 may determine a first optimized signal processing parameter (or set of processing parameters) that is determined based on a first evaluation metric (e.g., precision or other evaluation metric) and a second optimized signal processing parameter (or second set of processing parameters) that is determined based on a second evaluation metric (e.g., recall or other evaluation metric) that is different from the first evaluation metric. The ADV may apply the first optimized signal processing parameter (or first set) in response to a first driving scenario and apply the second optimized signal processing parameter (or second set) in response to a second driving scenario.

For example, based on the speed of the ADV (e.g., being above a threshold), or if the ADV is driving in an area with many pedestrians, the ADV may select a set of parameters that prioritizes or optimizes a first metric (e.g., reducing false negatives). When the driving scenario changes (e.g., the ADV is below the speed threshold or is no longer driving in an area with many pedestrians, the ADV may select a second set of parameters that prioritizes or optimizes a different metric (e.g., precision or average precision).

Various sets of image signal processing parameters may be generated and associated with different conditions and driving scenarios including those mentioned and those not mentioned.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method, comprising:
obtaining one or more raw images captured from sensors of an autonomous driving vehicle (ADV);
applying a signal processing parameter to the one or more raw images, resulting in one or more processed images;
applying an object detection algorithm of the ADV to the one or more processed images;
determining a score of the object detection algorithm as applied to the one or more processed images; and
determining an optimized signal processing parameter based on the score of the object detection algorithm and the signal processing parameter, wherein the optimized signal processing parameter is uploaded to the ADV for autonomous driving.

2. The method of claim 1, wherein determining the optimized signal processing parameter includes determining and applying a plurality of signal processing parameters and selecting one of the plurality of signal processing parameters that corresponds to a highest score of the object detection algorithm.

3. The method of claim 1, wherein determining the optimized signal processing parameter includes generating one or more signal processing parameters using a random number generator.

4. The method of claim 1, wherein the signal processing parameter includes a white balance gain.

5. The method of claim 1, wherein the signal processing parameter includes a color saturation.

6. The method of claim 1, wherein the signal processing parameter includes a noise reduction strength.

7. The method of claim 1, wherein the score is determined based on area of overlap of a detected bounding box and ground truth and an area of union of the detected bounding box and the ground truth.

8. The method of claim 7, wherein the score is further determined based on one or more true positives determined based on a ratio of the area of overlap of the detected bounding box and the ground truth and the area of union of the detected bounding box and the ground truth.

9. The method of claim 7, wherein the score is further determined based on one or more false positives determined based on a ratio of the area of overlap of the detected bounding box and the ground truth and the area of union of the detected bounding box and the ground truth.

10. The method of claim 7, wherein the score is further determined based on one or more false negatives determined based on the ground truth not being detected.

11. The method of claim 1, wherein determining the optimized signal processing parameter includes determining a first optimized signal processing parameter that is associated with a first light condition and a second optimized signal processing parameter that is associated with a second light condition, wherein the ADV applies the first optimized signal processing parameter in response to sensing the first light condition and applies the second optimized signal processing parameter in response to sensing the second light condition.

12. The method of claim 1, wherein determining the optimized signal processing parameter includes determining a first optimized signal processing parameter that is determined based on a first evaluation metric and a second optimized signal processing parameter that is determined based on a second evaluation metric that is different from the first evaluation metric, wherein the ADV applies the first optimized signal processing parameter in response to a first driving scenario and applies the second optimized signal processing parameter in response to a second driving scenario.

13. A computing device comprising:
a processor; and
a memory storing instructions that, when executed by the processor, configure the computing device to:
obtain one or more raw images captured from sensors of an autonomous driving vehicle (ADV);
apply a signal processing parameter to the one or more raw images, resulting in one or more processed images;
apply an object detection algorithm of the ADV to the one or more processed images;
determine a score of the object detection algorithm as applied to the one or more processed images; and
determine an optimized signal processing parameter based on the score of the object detection algorithm and the signal processing parameter, wherein the optimized signal processing parameter is uploaded to the ADV for autonomous driving.

14. The computing device of claim 13, wherein determining the optimized signal process parameter includes determining and applying a plurality of signal processing parameters and selecting one of the plurality of signal processing parameters that corresponds to a highest score of the object detection algorithm.

15. The computing device of claim 13, wherein determining the optimized signal process parameter includes generating one or more signal processing parameters using a random number generator.

16. The computing device of claim 13, wherein the signal process parameter includes a white balance gain.

17. An autonomous driving vehicle (ADV) comprising:
one or more cameras; and
a computing device that applies one or more optimized signal processing parameters to one or more raw images captured by the one or more cameras, wherein determining the one or more optimized signal processing parameters includes:
obtaining one or more raw training images captured from sensors;
applying one or more signal processing parameters to the one or more raw training images, resulting in one or more processed images;
applying an object detection algorithm of an ADV to the one or more processed images;
determining a score of the object detection algorithm as applied to the one or more processed images; and
determining the one or more optimized signal processing parameters based on the score of the object detection algorithm and the one or more signal processing parameters.

18. The ADV of claim 17, wherein the signal process parameter includes a white balance gain (e.g., a static white balance gain).

19. The ADV of claim 17, wherein the signal process parameter includes a color saturation.

20. The ADV of claim 17, wherein the signal process parameter includes a noise reduction strength.
